(19) United States
(12) Patent Application Publication
(10) Pub. No.: US 2004/0004922 A1
(43) Pub. Date: Jan. 8, 2004

(54) Materials for optical medium copy-protection transiently reacting to a reader beam

(76) Inventors: Richard H. Selinfreund, Guilford, CT (US); Scott Gerger, Des Moines, IA (US); Donald R. Goyette, Plainfield, CT (US); Michael Colandreo, Longwood, FL (US); Rakesh Vig, Durham, CT (US); Junzhong Li, New London, CT (US); Ewell Cook, Colchester, CT (US); Tomeko Turner, Uncasville, CT (US)

Correspondence Address: PILLSBURY WINTHROP, LLP, P.O. BOX 10500, MCLEAN, VA, 22102, US

(21) Appl. No.: 10/418,898

(22) Filed: Apr. 17, 2003

Related U.S. Application Data
(60) Provisional application No. 60/389,223, filed on Jun. 17, 2002.
(60) Provisional application No. 60/390,647, filed on Jun. 21, 2002.
(60) Provisional application No. 60/391,773, filed on Jun. 25, 2002.
(60) Provisional application No. 60/391,857, filed on Jun. 26, 2002.
(60) Provisional application No. 60/393,397, filed on Jul. 2, 2002.
(60) Provisional application No. 60/413,934, filed on Sep. 26, 2002.

(51) Int. Cl. G11B 7/00

(52) U.S. Cl. 369/53.21; 430/270.11; 369/275.3; 369/283

(57) ABSTRACT

A method and system for providing copy-protected optical medium using transient optical state change security materials capable of changing optical state and software code to detect such change in optical state.

### RELATED APPLICATIONS

This application incorporates by reference the disclosures of, and claims the benefit U.S. Provisional Application No. 60/389,223, filed Jun. 17, 2002, U.S. Provisional Application No. 60,390,647, filed Jun. 21, 2002, U.S. Provisional Application No. 60/391,773, filed Jun. 25, 2002, U.S. Provisional Application No. 60/391,857, filed Jun. 26, 2002, U.S. Provisional Application No. 60/393,397, filed Jul. 2, 2002, and U.S. Provisional Application No. 60/413,934, filed Sep. 26, 2002.

### BACKGROUND OF THE INVENTION

1. Field of the Invention

The present invention generally relates to transient optical state change security materials reactive to wavelengths used in optical disc readers, in particular to wavelengths produced by CD and DVD optical readers. Such materials may be used by directed application to optical medium to effectuate copy-protection. More specifically, the dyes may be used to manufacture optically readable digital storage medium that protects the information stored thereon from being copied using conventional optical medium readers, such as CD and DVD laser readers, but permits reading of the information from the digital storage media by the same readers.

2. Description of the Related Art

Data is stored on optical media in the form of optical deformations or marks placed at discrete locations in one or more layers of the medium. Such deformations or marks effectuate changes in light reflectivity. To read the data on an optical medium, an optical medium player or reader is used. An optical medium player or reader conventionally shines a small spot of laser light, the “readout” spot, through the disc substrate onto the data layer containing such optical deformations or marks as the medium or laser head rotates. Two common types of optical media are the CD disc, providing a maximum storage space of about 650 megabytes of data on a single-side (SS), single-layer (SL) disc, and the DVD disc providing about 4.37 GB (1GB=2³¹ bytes) on a single-sided (SS), single-layer (SL) disc. The ECMA Technical Committee TC31 was established in 1984 for the standardization of Optical Discs and Optical Disc Cartridges, making contributions to ISO/IEC SC23 with respect to International Standards.

In conventional “read-only” type optical media (e.g., “CD-ROM”), data is generally encoded by a series of pits and lands that are metallized. A readout spot directed from the non-metallized side is reflected in a manner that the light of readout spot is reflected back into a photosensor in the reader. When referenced from the laser reading side, pits are technically referred to as bumps. The transitions between pits and lands, and the timing in between such transitions, represent channel bits. Thus the pit and lands in themselves are not representations of a sequence of zeros or ones. Typically, in CDs 14 channel bits make up a data symbol that translates to an 8 bit data value, in a process referred to as 8 to 14 modulation (EFM). DVD uses a modified version of EFM, known as EFM+ to convert 8-bit data directly into 16 channel bits. The NRZI (non-return to zero inverted) wavefrom representation is used to interpret the binary sequence on the disc.

Microscopic pits formed in the surface of the plastic medium are arranged in tracks, conventionally spaced radially from the center hub in a spiral track originating at the medium center hub and ending toward the medium's outer rim. The pitted side of the medium is conventionally coated with a reflectance layer such as a thin layer of aluminum or gold. The “pits” as seen from the metallized side, are also referred to “bumps” when referencing view from the laser-read side. A lacquer layer is typically coated on the pit side as a protective layer.

The intensity of the light reflected from a read-only medium's surface measured by an optical medium player or reader varies according to the presence or absence of pits along the information track. When the readout spot is over a land, more light is reflected directly from the disc than when the readout spot is over a pit. As defect-induced errors may interfere with read, all optical discs employ error management strategies to eliminate the effect of such errors.

Error management strategies include powerful error-correction codes (ECC) which comprise algorithms that attempt to correct erros due to defects such that the optical disc works as intended. ECC's exist that are simulataneously optimized for both long and short error bursts, such as the Reed-Solomon (RS) codes. If code words are interleaved before recording, a very long burst may be reduced to a manageable number of errors within each recovered code word. Interleaving allows the drive to recover from burst (i.e, when a whole packet of bytes is misread) by distributing the data non-sequentially around one of the disc's tracks. As the drive actually reads data one revolution at a time, the data can be un-interleaved to be read. CDs conventionally employ the Cross Interleave Reed-Solomon Code (CIRC), a combination oft he Reed-Solomon code and interleaving concepts, for error correction. Using a two-stage Reed-Solomon encoder, CIRC conventionally generates 32 bytes output for a set of 24-byte input, leading to one bit out of every 4-bit coded data to be redundantly added for error correction and detection (as so-called code rate of ¾). CIRC corrects error bursts up to 3,500 bits (approx. 2.4 mm in length) and compensates for error bursts up to 12,000 bits (approx. 8.5 mm in length) such as caused by minor scratches.

Modulation is employed after encoding, such as eight-to-fourteen modulation (EFM), which employs 3 merging bits, with respect to CDs to assure a maximum length for a pit or land of 11U (U standing for the length of one bit), and a minimum length of 3U. The latter reduces the effect of jitter and other distortions on the error rate. EFM guarantees that there will not be extended gaps such that the laser looses track of the spiral data by assuring that some of the 14 bits will be 1 s. NRZI is then applied to the binary sequence to form the desired pit-and-land combination to be molded on the CD. The ROM in each player contains a lookup table that reverses the process to decode the data. DVD discs conventionally employ RSPC error correction modulation.

Optical discs may be said to typically comprise seven major regions: a center hole, a clamping area, lead-in area, data area, lead out area, outer buffer zone and rim area. Both the center hole and clamping area are used for the fixture of the compact disc while the drive is reading data out. The lead-in area contains information pertaining to the disc and holds the volume table of contents, permitting the player to synchronize itself to the disc being played. The table of contents (TOC) for a CD is contained in the Q-channel, and comprises absolute timecodes for each track (as minutes, seconds and frames). Optical readers will not recognize the disc if they cannot read the TOC. A DVD lead-in zone comprises a initial zone, reference code zone, buffer zone 1, control data zone, and buffer zone 2. The Control Data Zone comprises physical format information (disc category and version number, disc size and maximum transfer rate, disc structure, recoding density, data zone allocation, BCA descriptor and reserved portions), disk manufacturing information and content provider information. The data area, or program area, is where the stored digital content is placed. Subcode data is placed within the data area to encode the absolute and relative position such that the laser reader can determine where it is, and may include other information such as in audio CDs the title of a song. The Lead-out area contains simple codes which allow the player to recognize the end of the disc. The outer buffer zone and lead-out area conventionally comprise at least 0.5 mm in width (measured radially). The rim area is the unrecorded part at the edge of the optical disc. The combination of lead-in area, program area and lead-out area, and outer buffer zone is commonly referred to as the Information area.

Optical discs may also comprise other areas such as a Power Calibration Area (PCA) and Program Memory Area (PMA) as found in CD-Rs. Each area is limited by convention to a specific portion of the disk. For example, a CD audio logic structure comprises an inner buffer zone from radius 22-23 mm, the lead-in area from radius 23-25 mm, the program area from radium 25-58 mm, the lead-out area from radium 58-58.5 mm, the outer buffer zone from radius 58.5-59 mm and the rim area from radius 59-60 mm. In DVDs, the lead-in area comprising physical sectors 1.2 mm wide or more adjacent to the inside of the data area, while the lead-out area comprises physical sectors 1.0 mm wide or more adjacent to the outside of the data area. Such areas or sectors should be distinguished from the data itself, which conventionally, in CDs and DVDs are not arranged in distinct physical units, but rather as indicated above are organized into frames which are intricately interleaved so that damage to the disc will not destroy any single frame, but only small parts of many frames.

The optical reader, such as the CD or DVD reader, has the job of finding and reading the data stored as bumps on the CD. In a conventional player a drive motor spins the disc. A CD drive motor is designed to precisely control rotation of the disc between 200 and 500 rpm depending on which tract is being read. A laser and lens system focus light on the bumps, and an optical pickup receives reflected light. A tracking mechanism moves the laser assembly so that the laser's beam can follow the spiral track, conventionally moving the laser outward from the center as the CD is played. As the laser moves outward from the center of the disc, the bumps move past the laser faster, as the speed of the bumps is equal to the radius times the speed at which the disc is revolving (rpm). A spindle motor is conventionally employed to slow the speed of the CD when the laser is reading further and further out from the center of the disc permitting the laser to read at a constant speed, such that the data is read from the disc at a constant speed.

The semiconductor laser utilized, the spread of its wavelength, and its operational temperature affect the wavelength read by the pick up head (PUH) of the reader. DVD readers presently utilize lasers that produce a wavelength of about 630 to about 660 nm, with standard DVD readers measuring a wavelength of 650±5 nm and standard DVD-R readers measuring a wavelength of 650+10/−5 nm. CD readers presently utilize lasers that produce wavelengths between about 640 nm to about 840 nm, with standard CD readers having PUHs reading a wavelength of about 780 nm. As would be understood by one of skill in the art, the PUHs can detect only those reflected beams that fall within a certain angular deviation from the incident beam. For example, a typical DVD-R requires that the radial deviation be no more than ±0.80° and tangential deviation no more than ±0.30°.

Optical characteristics of DVDs and CDs also differ. Reflectively of a DVD is from about 45 to about 85%, while the reflectivity of a CD is about 70% minimum. CD has a pit length of about 0.822 to 3.560 μm and a track pitch of 1.6 μm, while DVD has a pit length of about 0.4 μm to about 1.866 μm (or about 0.440 μm to about 2.054 μm) and a track pitch of 0.74 μm. DVDs use smaller tracks (about 0.74 μm wide) than CDs (about 1.6 μm).

The scan speed and rotational speed of CDs and DVDs also differ, with CDs being scanned at a rate of about 1.2 to about 1.4 m/sec with a rotational speed of about 200 to 500 rpm, while DVDs are scanned from about 3.49 m/s (single layer) to about 3.84 m/s (dual layer) with a rotational speed of from about 570 to about 1600 rpm.

The vast majority of commercially-available software, video, audio, and entertainment pieces available today are recorded in read-only optical format. One reason for this is that data replication onto read-only optical formats is significantly cheaper than data replication onto writable and rewritable optical formats. Another reason is that read-only formats are less problematic from a reading reliability standpoint. For example, some CD readers/players have trouble reading CD-R media, which has a lower reflectivity, and thus requires a higher-powered reading laser, or one that is better “tuned” to a specific wavelength.

Optical media of all types have greatly reduced the manufacturing costs involved in selling content such as software, video and audio works, and games, due to their small size and the relatively inexpensive amount of resources involved in their production. They have also unfortunately improved the economics of the pirate, and in some media, such as video and audio, have permitted significantly better pirated-copies to be sold to the general public than permitted with other data storage media. Media distributors report the loss of billions of dollars of potential sales due to high quality copies.

Typically, a pirate makes an optical master by extracting logic data from the optical medium, copying it onto a magnetic tape, and setting the tape on a mastering apparatus. Pirates also sometimes use CD or DVD recordable medium duplicator equipment to make copies of a distributed medium, which duplicated copies can be sold directly or used as pre-masters for creating a new glass master for replication. Hundreds of thousands of pirated optical media can be pressed from a single master with no degradation in the quality of the information stored on the optical media. As consumer demand for optical media remains high, and because such medium is easily reproduced at a low cost, counterfeiting has become prevalent.

WO 02/03386 A2, which asserts common inventors to the present application, discloses methods for preventing copying of data from an optical storage media by detecting optical dis-uniformities or changes on the disc, and/or changes in readout signal upon re-reading of a particular area on the optical storage medium, in particular those caused by light-sensitive materials, such as dyes, which may affect the readout wavelength by absorbing, reflecting, refracting or otherwise affecting the incident beam. Software control may be used to deny access to content if the dis-uniformity or change in read signal is not detected at the position on the disc wherein the dis-uniformity or change is anticipated. The disclosure of WO 02/03386 A2 is incorporated herein in its entirety by reference.

A preferred embodiment described in publication WO 02/03386 A2 comprises light-sensitive materials are optically-changeable security materials that are positioned upon the optical disc in a manner that they do not adversely affect the data-read of the readout signal in one optical state but upon exposure to the wavelength of the optical reader incident beam covert to a second optical state, preferably in a time-delayed fashion, that does affect the data-read of the readout signal. In a preferred embodiment described in WO 02/03386 A2, the optically-changeable security material only transiently changes optical state and its optical state reverts over time.

It has been discovered by the present inventors that the optimal characteristics for such preferred transient optically-changeable security materials described in publication WO 02/03386 A2 depend upon a number of factors, including, the characteristics of the incident beam generated by the laser reader used (such as the beam intensity and wavelength), the particular materials used to fabricate the optical disc in particular with respect to the optical characteristics of such materials with respect to the reading beam (such as refractive index and birefringence), the particular formatting of the disc (such as pit depth), where the optically-changeable security material is positioned on or within the disc (e.g., on the surface versus in a layer of the disc/in the data section of the disc versus), the optical characteristics of other materials that may be introduced to effectuate incorporation of the optically-changeable security material onto or into the disc, the characteristics of the pickup head (PUH) of the optical reader in particular with respect to readout wavelength and angle of deviation permitted for pickup of reflected light emanating from the incident beam, the reading characteristics of the optical reader system in particular related to scan velocity, the time for re-scan, and rotational speed of the disc. For example, the material should not change state too quickly so as not to allow the PUH to observe both states. On the other hand, it should not change state too slowly so as to eventuate in a disc that would take non-commercially acceptable times for validation of the disc and read.

An optimal transient optical state change security material should be thermally and photochemically stable under conditions of optical use and at ambient conditions for a significant period of time. It should be soluble in a matrix that comprises the disc, or that can be adheredly-applied to the disc. An optimal transient optical state change security material should revert to its state without the need for extraneous inputs of energy, and should demonstrate a change in optical state at the incident wavelength of the reader.

There is a need for identifying optimal transient optical state change security materials that may be employed in a manner described in WO 02/03386 A2 to effectuate copy-protection of optical discs, in particular CDs and DVDs that conform to ISO/IEC standards when read by their respective ISO/IEC standardized readers. In particular there is a need for identifying materials that may be used in such copy protection methodologies without requiring modification to optical medium readers.

### DEFINITIONS

“Data Deformation”: a structural perturbation on or in an item that represents stored data and can be read by an optical reader.

“Dye”: an organic material detectable by optical means.

“Fabry-Perot Interferometer”: an Interferometer making use of multiple reflections between two closely spaced reflective surfaces, and typically has a resolvance of λ/Δλ=m r/1−r

“Interferometer”: a device employing two or more reflective surfaces to split a beam of light coming from a single source into two or more light beams which are later combined so as to interfere in a constructive or destructive manner with each other.

“Optical Medium”: a medium of any geometric shape (not necessarily circular) that is capable of storing digital data that may be read by an optical reader.

“Optical Reader”: a Reader (as defined below) for the reading of Optical Medium.

“Optical State Change Data Deformation”: refers to an optical deformation on an item representative of data that is associated with an Optical State Change Security Material in such a manner that the data read of the deformation by an optical reader changes with the optical state of the Optical State Change Security Material.

“Optical State Change Security Material”: refers to an inorganic or organic material used to authenticate, identify or protect an Optical Medium by changing optical state from a first optical state to a second optical state.

“Permanent Optical State Change Security Material”: refers to a Transient Optical State Change Security Material that undergoes change in optical state for more than thirty times upon read of the Optical Medium by an Optical Reader.

“Reader”: any device capable of detecting data that has been recorded on an optical medium. By the term “reader” it is meant to include, without limitation, a player. Examples are CD and DVD readers.

“Read-only Optical Medium”: an Optical Medium that has digital data represented in a series of pits and lands.

“Recording Layer”: a section of an optical medium where the data is recorded for reading, playing or uploading to a computer. Such data may include software programs, software data, audio files and video files.

“Re-read”: reading a portion of the data recorded on a medium after it has been initially read.

“Transient Optical State Change Security Material”: refers to an inorganic or organic material used to authenticate, identify or protect an Optical Medium by transiently changing optical state between a first optical sate and a second optical state and that may undergo such change in optical state more than one time upon read of the Optical Medium by an Optical Reader in a manner detectable by such Optical Reader.

“Temporary Optical State Change Security Material”: refers to an Optical State Change Security Material that undergoes change in optical state for less than thirty times upon read of the Optical Medium by an Optical Reader.

For the purpose of the rest of the disclosure it is understood that the terms as defined above are intended whether such terms are in all initial cap, or not.

### SUMMARY OF THE INVENTION

The present invention provides for a copy-protected optical medium, employing transient optical state change security materials including dianthrylfulgides, dicyano derivatives of dianthrylfulgides, anthracene derivatives, thiazine derivatives, and syprooxazines.

The present invention also provides a method for ascertaining those compounds displaying transient characteristics induced by exposure to read beam of an optical reader such that the change can be detected by the uptake head of the optical reader.

The present invention also provides a method for improving copy protection using transient optical state change security materials by associating such materials with the lead out region of an optical disc.

The present invention further provides a method for improving copy protection using transient optical state change security materials using the materials to form an interferometer on the disc such that reflectivity back to the source is determined by the state in which the transient security material is in.

### BRIEF DESCRIPTION OF THE DRAWINGS

The accompanying drawings, which are incorporated in and constitute part of the specification, illustrate presently preferred embodiments of the invention, and together with the general description given above and the detailed description of the preferred embodiments given below, serve to explain the principles of the invention.

FIG. 1 (prior art) illustrates the basic physical specification of a compact disc viewed from the read-out surface;

FIG. 2 (prior art) illustrates the cross section of a compact disc;

FIG. 3 (prior art) illustrates an NRZI waveform and its corresponding binary sequence;

FIG. 4 illustrates schematically the ultraviolet and visible spectra (4A), and refractive index spectra (4B), of a 1×10−4 molar solution of Aberchrome 540 after quantitative conversion from its uncolored (1) to its colored (2) form.

FIG. 5 illustrates a cross-section of an optical medium embodiment comprising a transient optical state change security material between two substrates.

FIG. 6 illustrates thiazine compounds that may find use in the present invention designed to evince an optical state change when impinged upon by a wavelength of about 400 nm to 840 nm.

FIG. 7 illustrates a multi-layer optical disc embodiment of the present invention having reflective layer, dye layer, and transparent substrate.

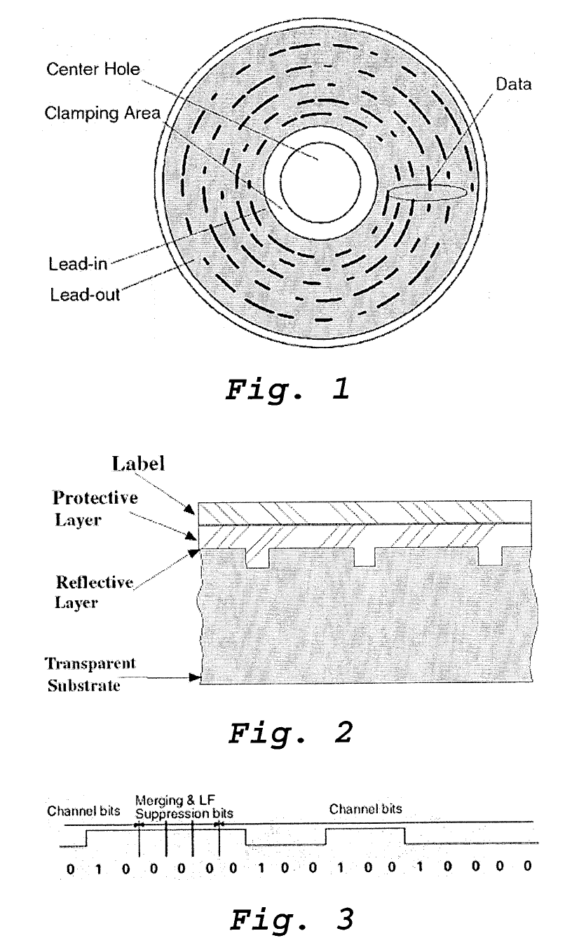

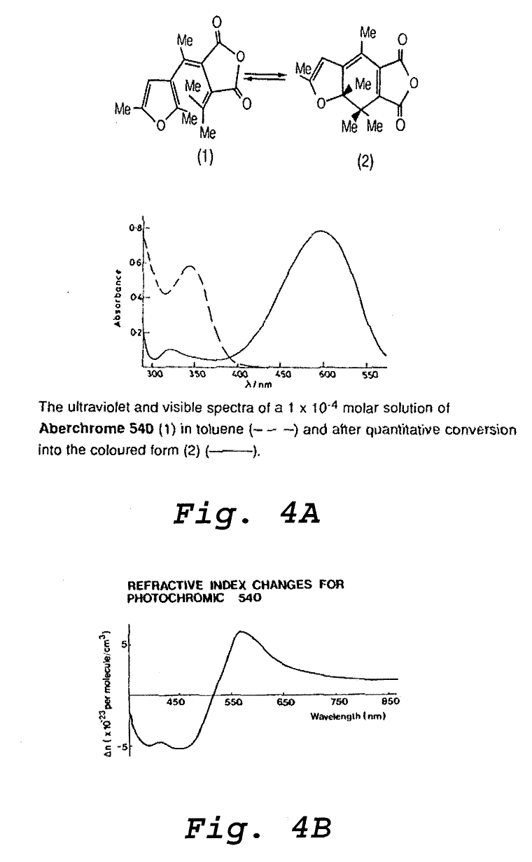

### DETAILED DESCRIPTION OF THE INVENTION

The present invention provides for a copy-protected optical medium comprising transient optical state change security materials. There are disclosed methods for selecting those transient optical state change security materials that are optimized for particular optical discs and their corresponding optical readers, transient optical state change security materials that are optimized for detection by conventional CD and/or DVD readers, and disc application techniques for utilizing such transient optical state change security materials for effectuating an copy-protected optical disc.

As disclosed in WO 02/03386 A2, which asserts common inventors to the present application, transient optical state change security materials may be used to effectuate copy-protection of an optical disc by providing a change in optical state upon activation of the material by the incident reading laser beam, that is of such character that upon a second read of the area of the disc where the transient optical state change security material is located a change in data read is detected at the optical pickup head. The materials may be used to cause an uncorrectable error upon re-read of such a character that the error interferes with copying function of most optical readers that require oversampling in the copying process, and/or a uncorrectable/correctable error, or a change in interpretation of a data read, that due to an algorithm on the disc, which may be incorporated as an encryption code, and/or an algorithm incorporated into the reader and/or component associated with the reader, is used to authenticate the disc and permit copying only upon authentication.

The materials may also be used to effectuate complementary data sequences (CDSs) both of which are interpreted as valid, both of which are interpreted as erroneous, or one of which is interpreted as valid and the other as erroneous, or one of which is interpreted as erroneous and the other as valid. That is, the for example, the materials may be used to cause a pit to disappear altogether of change its length because part of it disappeared. It is preferred that the material be conformal with the data structure. Copy protection may be effected using CDSs by, for example, having the first valid data read attributable to the material in its unactivated state directing the reader to an erroneous track on the disc, while having the second valid data read attributable to the material in its activated state directing the reader to the correct track for further effectuating of the read. As would be understood, copying of the disc in such situation is hampered by resampling by the copying device (which reads two different valid data reads). When such error is detected, re-seek algorithms internal to the drive will cause the data stored in the tracking control to be re-read. If the optical state change security material is in its second state, and the second state is selected as to allow the underlying data to be read, the new address will be correct and the content on the disc will be able to be read. In one embodiment of such “spoofing” technique for copy-protection, the material is placed at the subcode level in the lead-in zone thus effecting the table of contents. The material may be placed at the microlevel in the CRC field. A copy of the disc incorporating data having the first valid data read alone would not work due to the failure of the data to direct subsequent reading to the correct track. The transient optical state change security material may also provide for a valid data state read in a first optical state, but an uncorrectable read error in a second optical state, making it significantly more difficult for a would-be copier of the disc to reproduce an operable disc by incorporating an uncorrectable error, such as a physical deformation, into the disc.

By “correctable error” it is meant an error which is correctable by the ECC used with respect to the optical disc system, while an “uncorrectable error” is an error which is not correctable. ECC are algorithms that attempt to correct errors due to manufacturing defects such that the opticaldisc works as intended. Error detection methods are conventionally based on the concept of parity. All optical discs employ error management strategies to eliminate the effect of defect-induced errors. It has been found that even with the most careful handling, it is difficult to consistently manufacture optical discs in which the defect-induced error rate is less than 10⁻⁶. Optical recording systems are typically designed to handle a bit-error rate in the range of 10⁻⁵ to 10⁻⁴. The size of the defect influences the degree of error associated with the defect. Thus some defects create such a marginal signal disturbance that the data are almost always decoded correctly. Slightly smaller defects might induce errors hardly ever. Macro or micro depositions may also be used to cause correctable or uncorrectable errors. For example, micro depositions may be of such size as to kill a data group that is fixable by C₁/C₂ of ECC of a CD, but if applied to kill enough groups may cause an uncorrectable error detectable by such software.

The type of transient perturbation that is desired to be effectuated, whether a correctable error, uncorrectable error, two or more complementary valid data sequences, a valid data sequence and a corresponding invalid data sequence and/or other detectable change at the optical pickup head, will dictate where on the disc the transient optical state change security material will be placed. For example, if a data change detectable by the optical pickup head is desired, the material should not of course be placed in the clamping zone. If there is a valid to valid, or erroneous to erroneous data state change, in order to allow easy detection it is preferred that the data state change causes a change in the values read. In error state to error state changes the level of severity of the errors preferably is different, thereby aiding detectability.

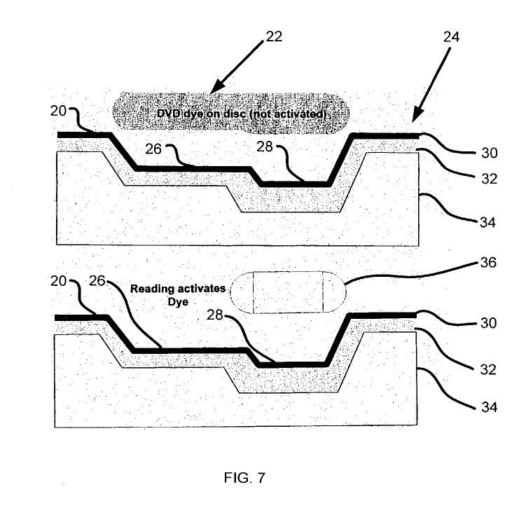

FIG. 7 illustrates a multi-layer optical disc embodiment of the present invention having reflective layer (30), dye layer (32), and transparent substrate (34), having pits and lands (20), (26), (28) (n.b., pits of different depth are shown in this embodiment but pits on optical media conventionally are of one depth). A side view cut-away view of a portion of the dye is shown at (22) unactivated, while a part of such portion is shown activated at (36).

Optimization of transient optical state change security materials for a particular reader is influenced in part by the particular materials used to fabricate each layer of the optical disc itself, and the material's position vis-à-vis such layers and the incident laser beam. It is therefore useful when selecting for such optimal security materials with respect to a particular reader that the material be placed on a disc of similar fabrication and placed for testing purposes in a manner similar to how they are ultimately to be placed.

Transient optical state change security materials that may be used to effectuate a copy-protected disc include, without limitation, a material that in response to a signal from the optical reader changes optical state so as: (1) to become more or less reflective; (2) to cause a change in refractive index; (3) to emit electromagnetic radiation; (4) to cause a change in color of the material; (5) to emit light, such as by (but not limited to) fluorescence or chemiluminescence; and/or (6) change the angle of any emitted wave from the optically-changeable security material in comparison to the angle of the incident signal from the optical reader.

Method for Optimizing Selection of Transient Optical State Change Security Materials for Use on Copy-Protected Optical Discs Read by An Defined Optical Reader

Transient optical state change security materials useful in effectuating a an optical state change that is detectable by the PUH of the optical reader, and which provides of a change of appropriate duration may be selected using the following methodology that employs an initial static screening test and dynamic confirmation test:

Static Screening Test

A static test stand is made from standard components of the optical reader which is used to read the optical medium. For example, for a DVD the laser has an excitation of 650 nm and the signal or optical pickup unit is the same specification as found in conventional DVD readers. The laser has an excitation of 650 nm as with a conventional DVD reader. The signal or optical pick up unit is the same specification found in the DVD readers. It is preferred that the excitation laser be unfocused as to any particular spot on the medium such that the material can be quickly exposed to the excitation wavelength. The static test stand is capable of making time, sensitivity and reflectivity measurements on sample substrates using collimated light.

Materials are analyzed by placing them on or in an optical medium that may be used in the optical reader and placing the medium on the static test stand. While not required in such preliminary static test, it is preferred that such candidate material be placed on or in the optical medium in a manner paralleling that for which it is designed, for example by spotting, and on optical medium fabricated from materials that are typically employed by medium read by such readers. Featureless optical discs, for example without molded pit features, may be utilized to allow measurement values independent of drive firmware on which to base development of materials and algorithms. Solvent in which the material is placed preferably is optimized so as not to photo-reduce itself upon exposure to the read beam. The rates of photo-reduction and oxidation of the materials where analyzed for differing concentrations of materials. One or more multiple coating may be screened. Materials demonstrating an acceptable rate of photo-reduction and/or oxidation, in particular in light of the typical speed of read by an optical reader designed to read the optical medium, were then screened in a dynamic test stand model set forth below. Preferable materials typically display a photo-bleach and recovery time of 1 minute or less and have high absorbency with respect to the read beam

Edge effects, due to the transition between bare polycarbonate and the material coated on the disc, may be detected when certain types of transient optical state change security material are used in certain concentrations. Preferably edge effects are limited such that the drive on which the medium is read is able to play through the edge effect without causing an error state, although as one of ordinary skill in the art would understand such edge effects as a change in reflectivity properties in the transition zone might be exploited in the practice of the present invention.

A Static tester may be comprised of a PUH or OPU from a DVD+RW recorder installed in a cabinet with controls for laser power and modulation, input connectors for modulation sources, and output connectors for measuring the laser output and the signal reflected from the test sample. Preferably the static tester is capable of making time, sensitivity, and reflectivity meaurements on sample substrates using collimated light.

Dynamic Confirmation Test

Materials determined in the static test to have acceptable rates of photo-reduction and oxidation may be placed on a dynamic optical disc drive. The drive should be controlled to seek the position were the security material was disposed, as by way of the drive control. Testing may be conducted to determine any or all of the following: whether presence of the materials on the disc were detectible by the PUH given the dynamics of the optical disc drive, whether the waveforms produced by the read and re-read of the disc where the material was located differed in a detectible manner from each other, and in particular whether the read speeds of the disc drive provided for reading the first optical state, detecting the second optical state upon and second read of the same position, and detecting a reversion from the second optical state to the first optical state upon a third read of the same position.

Measurements such as raw HF signal, equalized HF signal, EFM signal, recovered clock signal, tracking error signal, focus error signal, tracking drive current signal, focus drive current signal, spindle motor control signal, VCO control voltage, and RPM index signal may be made.

Other responses that may be measured during static and dynamic testing include, without limitation: static reflectivity before bleaching, dyanmic HF signal amplitude before bleaching, dynamic error statistics and drive speed changes before bleaching, static and dynamic bleach time, static reflectivity after bleaching, dynamic HF signal amplitude after bleaching, dyanamic error statistics and drive speed changes after bleaching, static and dynamic recovery time, dynamic HF signal amplitude after recovery, and dyanmic error statistics and drive speed changes after recovery

In one embodiment, the dynamic testing machine is a standard issue PC clone machine (Intel ATX motherboard, Intel P 4 CPU, and 512 mb of RAM) with the following installed in it: Acqiris, high speed, analog-to-digital conversion, “AcqirisLive”—oscilloscope-like (oscilloscope simulating) application for the Acqiris data acquisition card, CD-ROM, CD-RW, or DVD-ROM drives custom modified with rear panel output connectors that permit access to key test points in the drive, such as raw HF signal, equalized HF signal, EFM signal, recovered clock signal, tracking error signal, focus error signal, tracking drive current signal, focus drive current signal, spindle motor control signal, VCO control voltage, and RPM index signal, “CD Speed”—freeware CD “speed” (data transfer/throughput rate) measurement and testing application, “DVD Speed”—freeware DVD “speed” (data transfer/throughput rate) measurement and testing application. In another embodiment the dynamic test stand is a Plextor Combo Drive-based sytem, Plextor drives being ATAPI compliant. Preferred Plextor-based systems are retrofit with once-per-revolution index pulse generators for better quality signal measurements.

Optimizing of Coating Formulations for Selected Transient Optical State Change Security Materials

It has been discovered that coating formulation in which the transient optical state change security material may be placed for adherence to the optical disc may affect the detection of the multiple optical states by the PUH of the optical reader. Likewise the concentration of additives for wetting, surface tension etc. may affect the detection. Preferred coating formulations have been found to incorporate alcohols, polymers, and electron donor material. Electron donors, such as tertiary amines, were found to be particularly useful in affecting bleaching speed and recovery speed of certain redox dyes in which the bleaching mode is photoreduction and the coloring mode is air oxidation at room temperature.

### EXAMPLE 1

### Coating Formulation For Optical Disc

25 mg of transient optical state change dye is dissolved in 46.5 ml of 5% polyvinyl acetate in 1-methoxy-2-propanol, then 3.5 ml of triethanolamine is added, and the solution mixed thoroughly and then applied to standard spin coating to afford films.

### EXAMPLE 2

### Coating Formulation For Optical Disc

50 mg of transient optical state change dye is dissolved in 46.5 ml of 5% polyvinyl acetate in 1-methoxy-2-propynal, then 3.5 ml of triethanolamine is added, the solution is thoroughly mixed and then applied to standard spin coating to afford films.

### EXAMPLE 3

### Coating Formulation For Optical Disc

50 mg of transient optical state change dye is dissolved in 46. 5 ml of 5% polyvinyl acetate in 1-methoxy-2-propynal, then 3.4 ml of triethanolamine is added, and the solution is mixed thoroughly and then applied to standard spin coating to afford the films.

### EXAMPLE 4

### Coating Formulation For Optical Disc

50 mg of transient optical state change dye is dissolved in 2.5-5.0 ml of 1-propanol. 3.5 ml of triethanolamine was then added, and the solution was mixed throughly. The solution was then diluted with a PVA solution (1, 2 or 3%) comprising 1-methoxy-2-propanol.

### EXAMPLE 5

### Coating Formulation For Optical Disc

5 mg of dye was added to 10 ml of 6% polyvinyl alcohol in water, and 663 microliters of triethanolamine added thereto.

Transient Optical State Change Security Materials Optimized for DVD and CD and Their Respective Optical Readers

Thiazine Compounds

Of Particular Use In Copy-Protected CDs

The present invention provides in one embodiment for a copy-protected optical medium which may be read by an optical reader, employing transient optical state change security materials prone to a measurable (as judged by the optical reader) optical phase change in the wavelength range of about 400 nm to about 840 nm comprising certain thiazine derivatives of the formula:

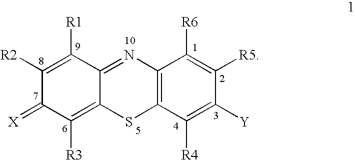

where R1 to R6 is hydrogen, alkyl, aryl, alkoxy, thioalkoxy, alkylamino, nitro, amino or halogen, and X and Y are either hydrogen, alkyl, aryl, alkoxy, thioalkoxy, alkylamino, nitro, amino and halogen, provided either of X or Y is a strong electron donating group to the thiazine backbone, and the other of X or Y is a strong electron withdrawing group with respect to the thiazine backbone. By attaching strong electron donating and electron withdrawing groups at the 3 and 7 positions, a push-pull structure may be obtained, forming structures with a significant bathochromic shift compared to methylene blue.

Preparation of Exemplar “Push-Pull” Thiazine Compounds For CDs

### EXAMPLE 1

### Phenothizine5-ium Tretraiodide Hydrate

A solution of phenothiazine (2.13 g, 11 mmoles) in chloroform (75 ml) was stirred at 5° C. and treated dropwise within 1 hour with a solution of iodine (8.38 g, 66 mmoles) in chloroform (175 ml). The mixture was stirred at 5° C. for an additional 30 minutes and the resultant precipitate was filtered, washed with chloroform, and then kept at vacuum at room temperature until the weight is constant. Afforded a black powder, 7.10 g (90%).

### EXAMPLE 2

### 3-(Dimethylamino)phenothiazine-5-ium Triiodide

A solution of phenothiazine-5-ium tetraiodide hydrate (0.417 g, 0.57 mmol) in methanol (10 ml) was stirred at room temperature and treated dropwise with a solution of dimethylamine (1.14 mmole) in methanol (2 ml). The mixture was stirred at room temperature for 3 hrs until the starting materials was consumed, as monitored by TLC (silica, CH₃OH/TEA). The precipitate was filtered and washed with small amount of methanol, afforded a black solid, 0.30 g (84%).

### EXAMPLE 3

### [7-(Dimethylamino)phenothiazine-3-ylidene]methane-1,1-dicarbonitrile

To the solution of 3-(dimethylamino)phenothiazine-5-ium triiodide (0.15 g, 0.24 mmole) in methanol (10 ml) was added malononitrile (0.095 g, 1.44 mmole) and sodium carbonate (0.28 g, 2.88 mmole), and the mixture was stirred at room temperature for 2 hrs, and the reaction was monitored by UV-Vis. Then brine and CH₂Cl₂ were added to the reaction mixture, and the CH₂Cl₂ layer was separated, washed with water, brine and dried (Na₂SO₄). Purification by column chromatography (SiO₂, CH₂Cl₂) afforded a deep blue band, and after removal of the solvent, afforded a purple solid.

FIG. 6 illustrates other thiazine compounds that may find use in the present invention designed to evince an optical state change when impinged upon by a wavelength of about 400 nm to 840 nm.

Of Particular Use In Copy-Protected DVDs

In another preferred class of thiazine compounds (2), R₁, R₂, R₃, R4 and R₅ can be alkyl, aryl, alkoxy, thioalkoxy, alkylamino, nitro, amino and halogen having absorbance in the 600-700 nm can be formulated and used as a DVD transient optical state change security material.

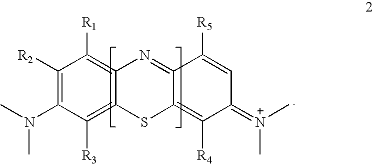

### EXAMPLE 4

### Screening DVD Transient Optical State Change Thiazines On Dynamic Test Stand

Thiazine compounds are placed in a coating formulation on the laser incident surface of a standard polycarbonate DVD using a Precision Spin Coater SCS model P-6708 (Indianapolis, Ind.). Preferably, coating edge effects which cause the pits to be occluded are avoided. Wetting agents, surface tension adjustments, spin profile design, are preferred to create a completely uniform coating, to produce the desired effect.

The dynamic test drive controls the “seek to” position were the materials were deposited, by way of the drive control. Photo bleach (colored to clear) and the rate of reversal (clear back to colored) are analyzed using the dynamic test stand. Testing is conducted to determine the following: 1) The waveforms produced by the read and re-read of the disc; 2) the located material was different in subsequent detection steps; 3) reversal of the second optical state to the initial optical state.

The potential of laser-incident surface deposition to produce an error—>valid data state transition is demonstrated. Three scope traces at approximately 2 minute intervals show the transformation of attenuated HF signal (error state) to almost full size HF signal (valid data state).

Particularly useful compounds of Formula 1 having absorbance maxima within the DVD wavelengths of conventional readers may include:

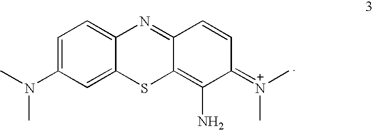

6-amino-7-(dimethylamino)(7-hydrophenothiazin-3-yl)]dimethylamine (3) (Abs. Max≈652 nm) and

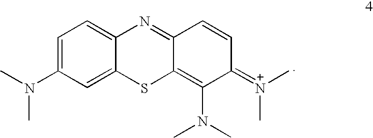

[6,7-bis(dimethylamino)(7-hydrophenothiazin-3-yl)]dimethylamine (4) (Abs. Max≈663 nm)

Molecules of Formula I containing electron donating groups were seen to reverse quicker than their counterparts employing electron withdrawing groups. Increasing the length of conjugation, however, increases the absorption wavelength. Based on such findings, the following structures should demonstrate absorptions as indicated, near or within the wavelength of laser light produced by a CD reader:

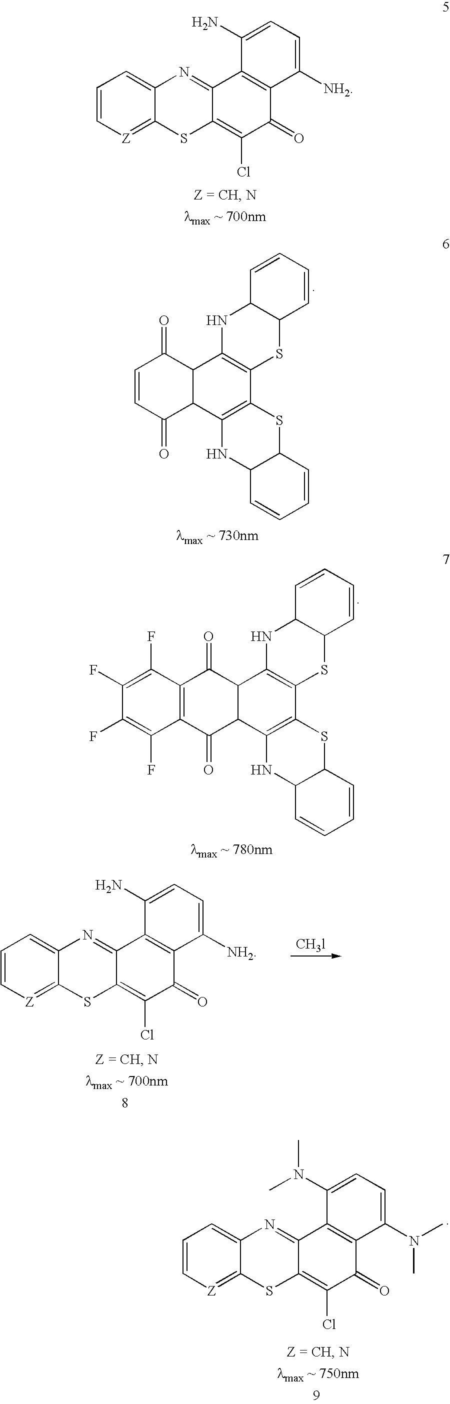

Other such thiazine materials that may find use in CD copy protection schemes based on the ability to cause transient optical changes include:

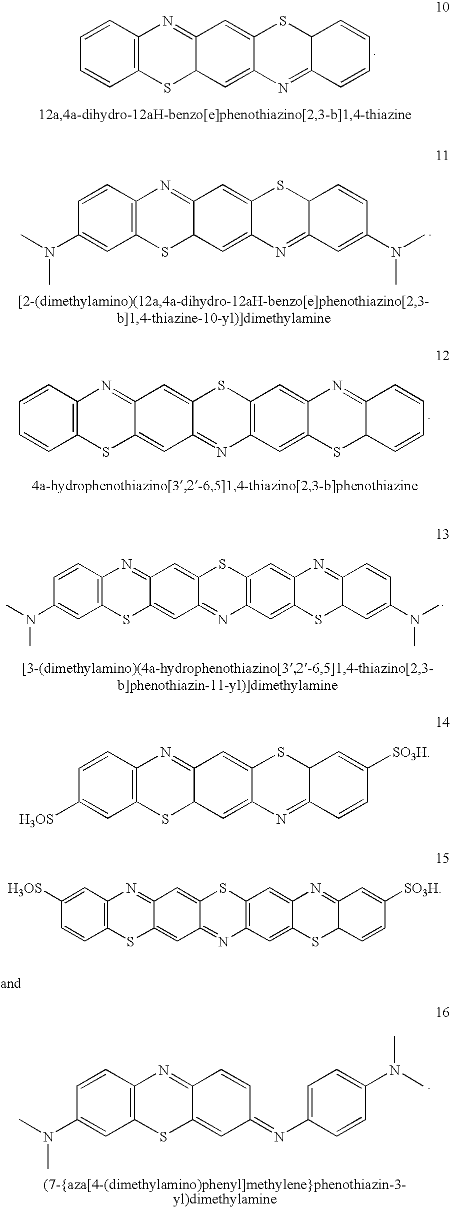

which may be synthesized by the following scheme:

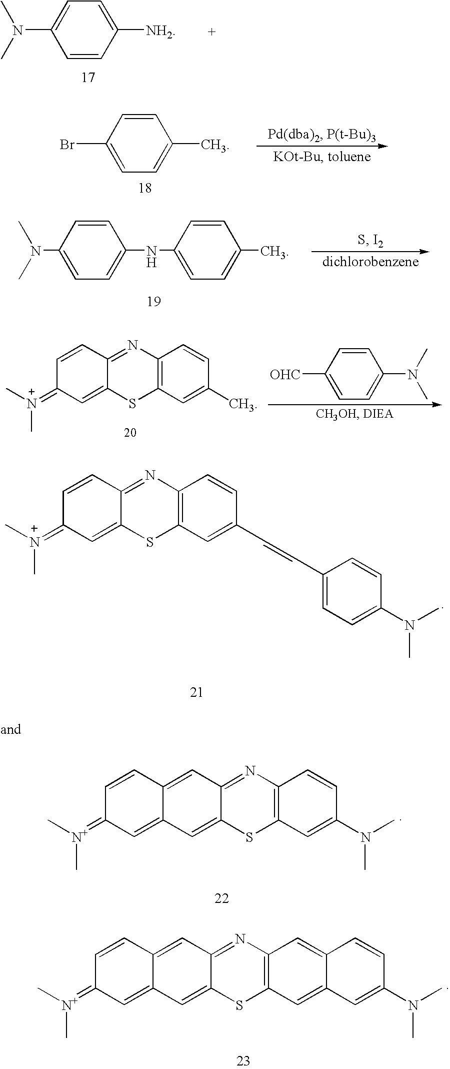

Surprisingly it was found that pallidium catalyst significantly enhanced the ability to modify such methylene blue-type structures to increase wavelengths.

Other phenothiazino-compounds may be formed using the chemistry described in Liebigs Ann. Chem. 740, 52-62 (1970) (J. Daneke and H.-W. Wanzlick). In particular nucleophilic moieties may be added to a phenazathionium cation generated in situ as described in such reference. Quinone compounds may be reacted with oxidized phenothiazine. The process allows for the synthesis of a number of 3-substituted phenothiazine derivative. The reference discloses that the phenothiazine may be reacted in a methanolic solution containing potassium acetate with anhydrous FeCl₃ solution. Advantageous phenothiazino-compounds for transient optical state change security materials include:

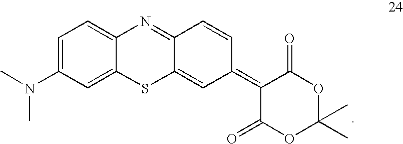

which may be synthesized as follows using the teachings of Daneke et al. reference:

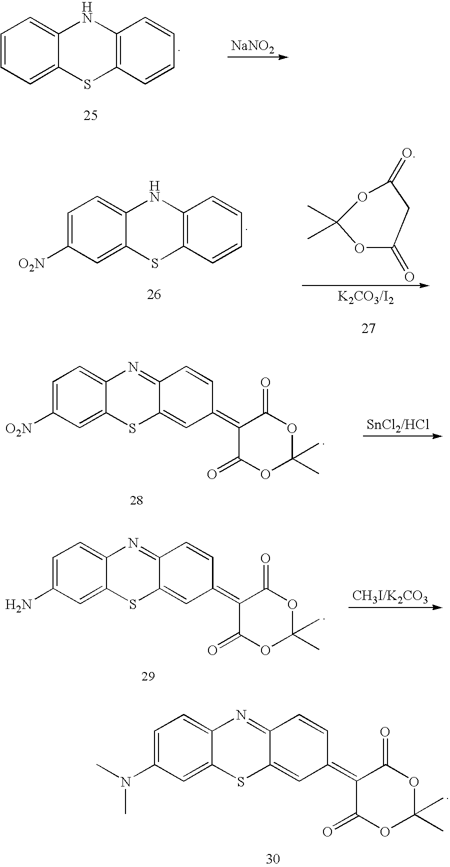

Other compounds that may be synthesized using the Daneke method that may find employment as transient optical state change security materials include:

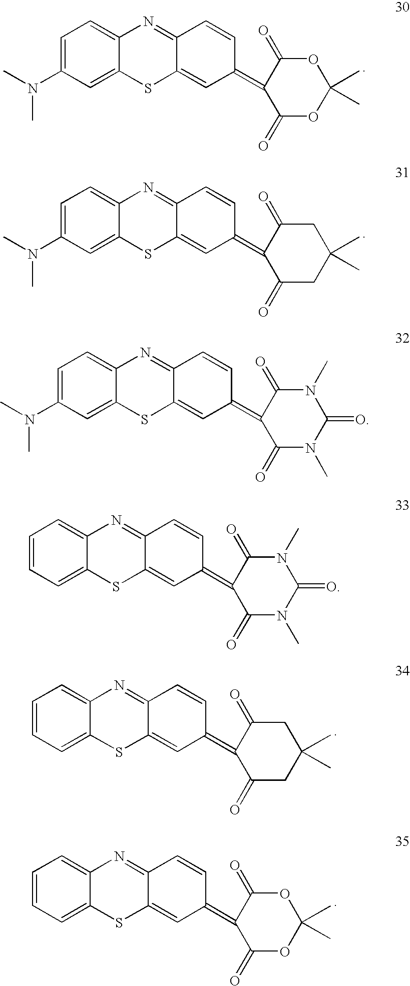

Anthracene Fulgides

Certain anthracene fulgides, in particular succinic anhydride congeners, demonstrate a refractive index change in the DVD range. Such compounds may be altered to shift such refractive index change to permit detection by CD readers having a wavelength of about 780 nm.

FIG. 4A demonstrates the ultraviolet and visible spectra of a the ultraviolet and visible spectra (4A), and refractive index spectra (4B), of a 1×10⁻⁴ molar solution of Aberchrome 540 after quantitative conversion from its uncolored (1) to its colored (2) form. While absorption is not much above 550 nm, there is evidenced a marked refractive index change at higher wavelengths.

Dicyanomethylene derivatives of (1) of FIG. 4A may be synthesized to effectuate a refractive index change in the wavelength of a CD reader (about 780 nm).

Bis(9-anthrylmethylene) succinic anhydrides, such as dianthyrlfulgide [XXXII] may also be found useful as transient optical state change security materials. Dianthyrlfulgide [XXXII] many also be modified by forming a dicyano congener [XXXIII] that shows a marked bathochromic shift. Compound XXXIII may be used effectuate a refractive index change detectable by the PUH of a CD reader. The compound may be prepared as follows:

### EXAMPLE 5

### Preparation of Starting Compound [36]

9-Anthraldehyde (20 g, 0.1 mol) and dimethyl succinate (7.3 g, 0.05 mole) are added to a suspension of potassium t-butoxide (13.6 g, 0.1 mol) in dry toluene (200 ml) and the mixture is stirred at room temperature overnight. The sparingly soluble dipotassium salt of 2,3-bis(9-anthyrlmethylene)succinic acid is acidified with 5 M hydrochlroic acid and filtered. The diacids are sparingly soluble in cold toluene wich contains unreacted anthracene and dimethyl succinate. As much toluene is decanted off as as possible, and the remainder is filtered. The mixture of diacids was dried and dissolved in acetyl chloride and left overnight. Excess acetyl choride is removed by distillation and the remaining mixture of fulgides is crystallized by dissolving in the minimum of dichloromethane and adding toluene. E,E-bis(9-anthrylfulgide) separates as red needles, melting above 300° C. The red solution in toluene turns yellow on exposure to white light. On irradiation with ultraviolet light (366 nm), or on warming above 20° C. in the dark, the yellow solution turns red.

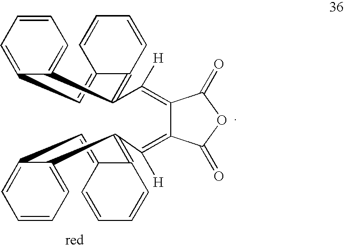

### EXAMPLE 6

### Preparation of Cyano-Compound [37] from [36]

A mixture of isomers of bis(9-anthrylmethylenesuccinic) anhydride [4.28] (0.8 g, 1.6 mmmol), malononitrile (1.2 g, 1.8 mmol), and diethylamine (2 g, 1.8 mmol) is placed in tetrohydrofuran (25 ml) and allowed to stand for 4 hours with occasional shaking. The intermediate salt (0.54 g) is separated and filtered off. A yellow powder [4.29] is obtained that which is dissolved in dichloromethane and cyclised with acetyl choride (2 ml). Pure E,Z-dicyano compound [XXXII] is obtained as deep purple rhomboid crystals (0.34 g) in 40% yield which give a deep red solution in toluene. Upon exposure to white light, the solution turns colorless. When the colorless solution is heated at 110° C. (by heating the toluene solution to boiling) the deep red color is restored.

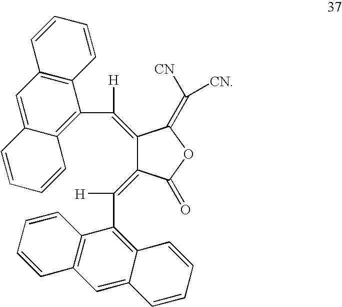

Spyroxoxazine Dyes

Certain spyrooxazine dyes can be activated by visible light and also demonstrate reverse photochromism, including [38] and [39].

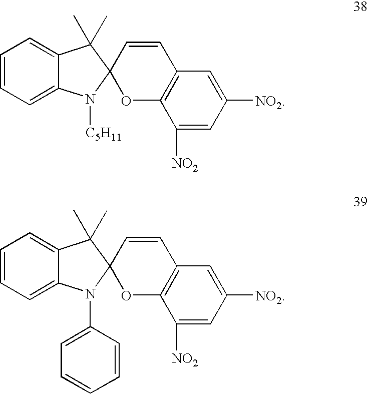

These compounds exhibited “reverse” photochromism in both solution and polymer film with the [89] dye exhibiting the fastest rate of comeback. Schemes for preparing and selecting 780 nm photochromic dyes are set forth below. “Reverse” photochromism at 780 nm is preferred, with achievement of at least 1000 bleach/comeback cycles more likely to be found with compounds that change color via unimolecular mechanism.

### EXAMPLE 7

### Synthesis of Indolinium Precursor Salt [42]

Indolinium salt [44] is not commercially available and also has to be synthesized from scratch. It may be made in a couple of steps (Scheme 2) using p-nitrophenyl hydrazine [40] and methyl isopropyl ketone [41] under the conditions of the Fischer indole synthesis. Methylation of the indole nitrogen of compound [43] followed by anion exchange to give the perchlorate salt would give compound [44]. Alternatively, the analog

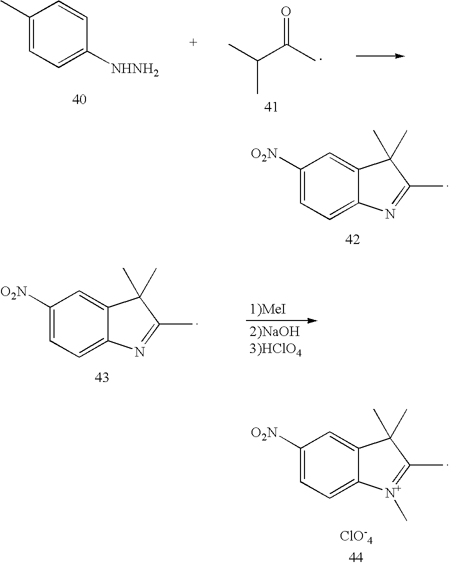

of compound [43] without the nitro group is commercially available if one wanted to go that route and eliminate one step of the synthesis (this may change absorption characteristics).

### EXAMPLE 8

### Preparation of Nakazumi Spyrooxanzine Dye [50]

Numerous research groups have investigated spiropyranes/spirooxazines/spirothiozines compounds described by Nakazumi et al. One of these dyes is noted as photochromic and has a peak at 725 nm (dye 10 in the paper=dye [50] in the synthesis below) which could be shifted even more by choosing the appropriate medium. In addition to the dye [50], compounds of similar structure with extended conjugation or different substituents may be prepared. The synthetic scheme for these may be similar to the one for the dye [50] shown below.

The synthesis of the desired dye [50] can be accomplished in four steps. Compound [45], which is commercially available, can be methylated at the 4-position using the corresponding cuprate reagent and then oxidized to the desired compound [46]. Condensation of compound [46] with the benzaldehyde of [47] gives the appropriate alkene [48].

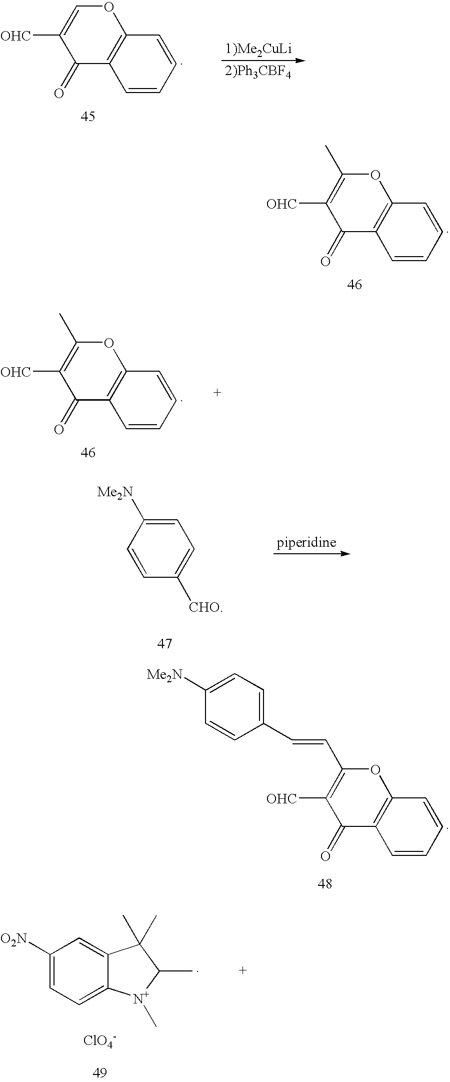

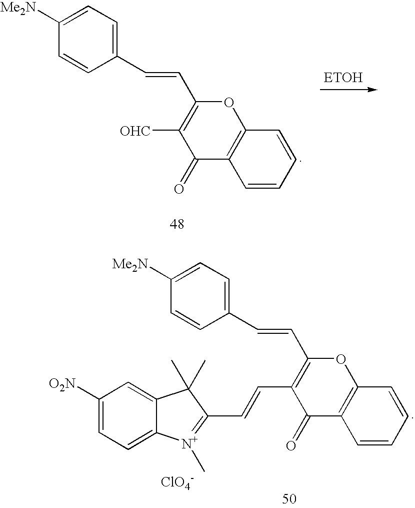

Other possible photochromes may include variations of dye [50] where different structures for aldehyde [47] and amine [48] may be chosen so that the overall system conjugation is altered. This may lead to different kinetics of photochromism as well as different absorption characteristics of a merocyanine dye.

1,2-Dihydroquinoline Derivatives

1,2-dihydroquinoline compounds, such as ethoxyquin (6-ethoxy-1,2-dihydro-2,2,4-trimethylquinoline), may also be used as transient optical state change security materials. For example, sigma bond weakening may be induced by reacting ethoxyquin, or a derivative thereof, with a methyl halide, such as methyl iodide, to produced a charged moiety (N⁺) capable of converting upon exposure to an incident wavelength about 780 nm to a transitory intermediate with different optical properties that may be detected by an PUH. The particular optical properties displayed may be altered by modifying the structure through addition of other moieties.

Placement of Transient Optical State Change Security Materials With Respect to Optical Data Structures on the Optical Discs

In General

As disclosed in WO 02/03386 A2, the transient optical state change security materials may be placed anywhere on or within the optical medium so long the PUH can detect the change in optical state. Such security materials may advantageously be placed in or on the optical medium on either the laser incident surface (“LI Method”) or the pit/land surface (a.k.a. the focal plane) of the optical medium (“FP Method”). Advantageously, changes in reflectivity, absorbance, optical clarity, and birefringence due to the application of the security materials may be monitored to assure that such materials do not interfere with industry standards, suggestive that the optical medium might not adequately perform in its reader. Audio Development's CD-CATS and DVD-CATS testers may be used to measure servo responses, HF signal amplitudes, and error behaviors.

Surface Application

The transient optical state change security materials may be applied topically to a surface of the optical medium or component of the optical medium during manufacture. Topical surface application may be by any of the imprinting techniques known to those of ordinary skill in the art, including, but not limited, air brush, industrial ink jet printing, desktop ink jet printing, silkscreen printing, sponge/brush application, air brushing, gravure printing, offset lithography, oleophilic ink deposition onto a wetted surface.

The material may also be spin coated. Spin coating a layer comprising the transient optical state change security materials may be a preferred method of application due to precision and uniformity requirements. Only minor process modification are typically necessary to implement in-line deposition by spin coating. The spin coat may be applied using any means known to those of ordinary skill in the art. For example, a precise, small quantity of dye may be placed in a radial line with the disc stationary and the disc subsequently spun to produce a precisely coated area. Conventionally spin coating entails a first ramp of acceleration to first speed, a first dwell time at first speed, a second ramp of acceleration to second speed, a second dwell time at second speed, a third ramp of acceleration to third speed, a third dwell time at the third speed, deceleration, and post conditioning (baking/drying/curing at defined temperatures for defined periods of time) The spin profile may be advantageously controlled to produce the desired coating. It is preferred that when such security materials are placed on an otherwise exposed surface of the completed optical medium, that the security materials be coated to protect against wear of the security material due to handling of the optical medium. Thus, for example when security material is applied to the laser-incident surface of a completed optical disc, it is advantageous that a hard-coating be placed over the security material to prevent wear or removal of the security dye from such surface.

The transient optical state change security materials may be coated onto the pit-surface prior to lacquering of the optical medium, addition of a second substrate (DVD) and/or application of any label. The later addition of such materials helps protect against removal and degradation of the security material. Any covering over the security material may further comprise a special filtering material, such as GE filtering polycarbonate.

The transient optical state change security materials may be placed at the pit/land surface.

In one embodiment, pit/land placement may makes use of pit geometries needed to accommodate dye deposition at the focal plane of the disc. Techniques such as Atomic Force Microscopy (AFM) may be used to verify dimensions. Optimal pit geometries for the particular security material may be determined by spin coating the material onto a surface having variable pit depths, determining which pits contain the materials as by, for example, microscopy, and determining which pit dimensions which may hold material after spin coating, actually allow for playback without the dye in them, and without errors. The optical medium with the material and determined pit geometries is then checked to determine whether a dual data state, error to valid, or valid to error, may be produced. Different radii, depths etc. may be investigated.

For example, without any limitation, a variable pit depth glass master for a CD may be made using a 350 nm thick photoresist and LBR (laser bean recorder) power step series, as to form 13 steps in random order, except for nominal depth tracts which contain 50 MB of pseudo-random user data, as follows: 160 nm (nominal pit depth), 120 nm, 150 nm, 180 nm, 160 nm (nominal), 210 nm, 240 nm, 270 nm, 160 nm (nominal), 300 nm, 320 nm, 350 nm, 160 nm (nominal). Similarly, a variable pit depth master for DVD may be made using a 200 nm thick photoresist and LBR power step series, as to form 13 steps in random order except the nominal depth tracks, wherein each track contains 360 MB of pseudo-random user data, as follows: 105 nm (nominal), 80 nm, 95 nm, 110 nm, 105 nm (nominal), 125 nm, 140 nm, 155 nm, 105 nm, 170 nm, 185 nm, 200 nm, 105 nm (nominal). The discs can be spun coat with material comprising transient optical state change security material, the pit depths incorporating the material determined, and pits of such dimensions analyzed for whether the impact upon read without the material when the optical medium is completed (metallized, lacquered etc.)

Detection from the laser-read side may be enhanced by including one or more deep pits in the substrate, such pits being made using a master designed to form multiple-depth pits. Detection may also be improved by optimizing pit geometry of the deep pits. Variable pit depth glass masters may be fabricated. For example, 350 nm thick photoresists and LBR power step series may be employed to produce different steps including nominal depth tracks for pseudo-random user data

The pits may advantageously be placed only in the outer 5 mm of the disc, or in the lead out region of the disc. In such case, only the outer portion of the disc, or lead out region, need be coated.

The deep pits may also be used to form an interferometer by placement of the security material with respect to the deep pit prior to metallization.

Placement of Transient Optical State Change Security Material in Lead-Out Region of the Optical Disc

As discussed above, the lead-out area of an optical disc is the area beyond the last information track. The main channel in the lead-out area contains null information. A DVD lead-out area comprises physical sectors 1.0 mm wide or more adjacent to the outside of the data area in single layered disc for a parallel track path disc, or the area comprising physical sectors 1.2 mm wide or more adjacent to the inside of the data area in layer 1 of the opposite track path disc. The lead-out area indicates that the end of the data has been reached.

It has been discovered that a transient optical state change security material may be placed in the lead out region in a spot of under 600 microns and be detected by the PUH of a typical optical reader by way of algorithmic control. Positioning the material in such area reduces the need to account for ECC correction codes that may come into play if the material is placed over the data area, or corruption of the table of contents and subsequent failure of disc read if the material is placed in the lead-in area of the disc.

Placement of Transient Optical State Change Security Material in Polycarbonate with Formation of Extended Pits Upon Molding Prior to Metallization to Form an Interferometer Along the Extended Pits

The transient optical state change security material may incorporated into the polycarbonate and deep pits (bumps from the read side) flanking one or more lands molded into the polycarbonate at predetermined locations. The pits may be constructed to be of such depth that as to form an interferometer between the enlarged bumps, when viewed from the read side, that fail to reflect sufficiently for read by the PUH of the optical reader when the security material changes state due exposure to the incident read laser beam. This system therefore employs two components: the transient optical state change security material distributed throughout the polycarbonate, and a interferometer, of the Fabry-Perot type (“FPI”).

The FPI works by varying the amount of light reflected back to a source. This variation is dependent on the intensity, angle and wavelength of the light entering the interferometer. The physical construction of an FPI, when viewed from the read-side, can be effectuated during the stamping procedure by creating one or more pits of extended depth flanking one or more lands. The glass master advantageously is modified to create such pits of extended depth. The deep pits act as the walls of the FPI, while the reflective land at the bottom acts as the primary reflective surface. By carefully selecting the transient optical phase change security material, under one set of conditions (intensity, wavelength, angle) there will be considerable reflectivity back to the source, while under a second set of conditions, there will be significantly less light reflected back to the source. These two states will be driven by the security material placed in the polycarbonate (PC).

The compound placed in the PC will need to meet one of the conditions described above. Since angle is fixed in a piece of optical media the compound will have to reflect either intensity or wavelength. This can be done with compounds that display changes in absorbance or refractive index when exposed to light energy at a specific wavelength. Compounds that change properties when heated may also be utilized, if enough heat can be absorbed from the read laser without interfering with the readability of the disc. The rate of change of this compound must also be appropriate for use with today's optical drives given speed of the read and re-read. A compound that changes state too quickly will not allow the PUH (=OPU optical pick-up unit) to observe both states. A compound that changes state too slowly will not be tolerated by a consumer or may never change at all because the rate of energy loss will be equal to the rate of energy gain.

If the interferometer is appropriately manufactured, and the transient optical state change security material chosen, the material in the PC will be essentially transparent to the PUH and all data will be read at one state. During the read, the material will absorb energy. When enough energy has been absorbed by the material its transmittance will decrease (less energy passes through) and it will cause a slight change in refractive index. In the second state with the transmittance decreased, if property designed, the input energy threshold for the FPI can be made to be crossed, and very little signal will be reflected. By carefully selecting the security material and its concentration in the PC, one can cause enough signal to the optical data structures so as to be able to read such data. One the other hand, if RI is changed when the material is activated by the read beam, the security material and its concentration, and the depths of the pits (from the non-read side) should be such as to result in a change in wavelength that crosses the FPI threshold resulting in a reduction in reflectivity, but the wavelength change should be small enough that normal sized optical data structures may still be resolved. It should be noted that the disc may have to be preformatted, such as is the case with CD-RW, if the automatic gain control (AGC) is inappropriately invoked based on ATIP information.

Placement of Transient Optical State Change Security Material Between Substrates Comprising the Optical Medium

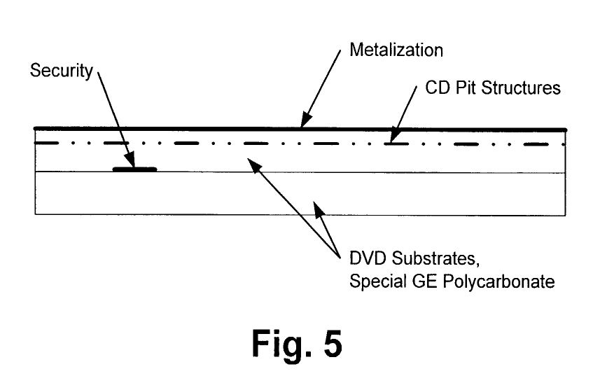

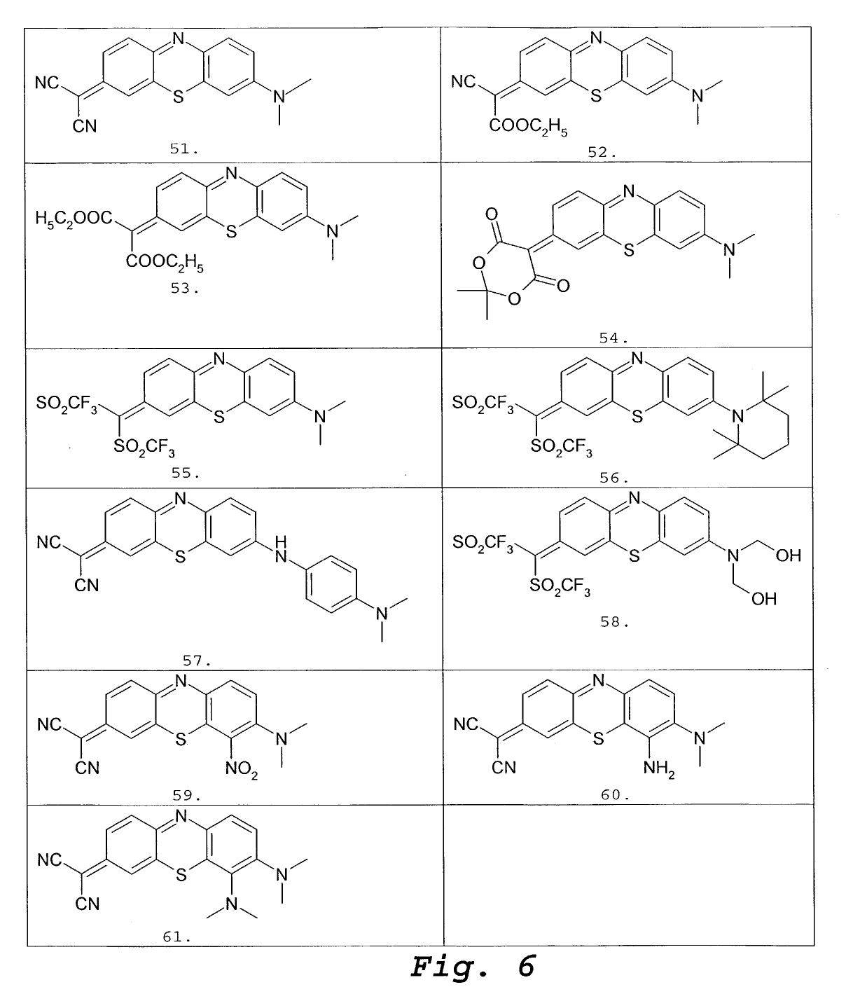

Dye may be deposited and encapsulated between substrates, for example an ambient protective polycarbonate, such as that produced by General Electric. Such placement eliminates optical hard coating, uses existing manufacturing processes, provides protection, and expands the possible dye chemistries that might be employed because read laser optical power density is, for example, greater at 0.6 mm from the pit surface than at 1.2 mm. FIG. 5 illustrates a cross-section of an optical medium embodiment comprising a transient optical state change security material between two substrates.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims. All documents cited herein are incorporated in their entirety herein.

We claim:

1. A method for fabricating an optical medium readable by an optical reader, said method comprising the steps of:
(a) molding a substrate so as to have a first major surface with information pits and information lands thereon and a second major surface that is relatively planar;
(b) applying a transient optical state change security material capable of converting from a first optical state to a second optical state upon exposure to the laser of said optical reader to at least a position of said first major surface;
(c) applying a reflective material over the first major surface so as to cover said information pits and information lands;
wherein the transient optical state change security material is selected from the group consisting of: phenothiazine, anthrancene, spyroxoxazine, and 1,2-dihydroquinoline compounds.

2. An optical disc readable by an optical reader generating a reading beam comprising:
a substrate having first major surface with one or more information pits and lands thereon, and a second major surface that is relatively planar, said information pits and lands convertible into digital data bits when read through the second major surface by said reading reading beam of said optical reader;
a transient optical state change security material dispersed throughout said substrate, said transient optical state change security material capable of existing in a first unactivated state and a second activated state; and
a reflective layer positioned over said information pits and lands;
wherein in at least two or more of said pits flanking a land are of sufficient depth to form a light-reflecting interferometer when the transient optical state material is in its first state but not in its second state, upon interface with said reading beam.

3. An optical disc readable by an optical reader generating a reading beam comprising:
a substrate having first major surface with one or more information pits and lands thereon, and a second major surface that is relatively planar, said information pits and lands convertible into digital data bits when read through the second major surface by said reading reading beam of said optical reader;
a transient optical state change security material capable of existing in a first unactivated state and a second activated state selectively applied along the first major surface so as to provide a valid digital data bit read when the transient state change security material is in its first unactivated state and its second activated state.

4. An optical disc readable by an optical reader generating a reading beam comprising:
a substrate having first major surface with one or more information pits and lands thereon, and a second major surface that is relatively planar, said information pits and lands convertible into digital data bits when read through the second major surface by said reading reading beam of said optical reader;
a transient optical state change security material capable of existing in a first unactivated state and a second activated state selectively applied along the first major surface so as to provide an erroneous digital data bit read when the transient state change security material is in its first unactivated state and a valid data bit read when it is in its second activated state.

5. An optical disc readable by an optical reader generating a reading beam comprising:
a substrate having first major surface with one or more information pits and lands thereon, and a second major surface that is relatively planar, said information pits and lands convertible into digital data bits when read through the second major surface by said reading reading beam of said optical reader;
a transient optical state change security material capable of existing in a first unactivated state and a second activated state selectively applied along the first major surface so as to provide an erroneous digital data bit read when the transient state change security material is in its first unactivated state and its second activated state.

6. An optical storage medium comprising:
an optical disc having a lead-in area, a data area, and a lead-out area;
a transient optical state change security material applied at least at one position in the lead-out area of said optical disc.

7. The optical storage medium of claim 6 wherein said transient optical state change security material is opaque in its first optical state and translucent in its second optical state.

8. The optical storage medium of claim 6 wherein said transient optical state change security material is translucent in its first optical state and opaque in its second optical state.

9. An optical medium comprising a compound of the following structure: 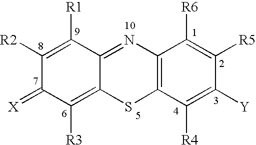
where R1 to R6 is hydrogen, alkyl, aryl, alkoxy, thioalkoxy, alkylamino, nitro, amino or halogen, and X and Y are either hydrogen, alkyl, aryl, alkoxy, thioalkoxy, alkylamino, nitro, amino and halogen, provided either of X or Y is a strong electron donating group to the thiazine backbone, and the other of X or Y is a strong electron withdrawing group with respect to the thiazine backbone,
wherein said compound is applied to an optical medium and is detectable on said optical medium by an optical reader producing a wavelength of from about 400 nm to about 840 nm by a transient change in optical state from an initial optical state to a second optical state.

10. The optical medium of claim 9 wherein said compound is detectable on said optical medium by an optical reader producing a wavelength of from about 640 nm to 840 nm.

11. The optical medium of claim 9 wherein said compound is detectable on said optical medium by an optical reader producing a wavelength of from about 770 nm to 830 nm.

12. The optical medium of claim 9 wherein the compound is associated with an optical data deformation in a manner such that the read of the optical data deformation is different when the compound is in its initial optical state and its second optical state.

13. A method for authenticating an optical medium having a number of data deformations thereon, said method comprising the steps of:
(1) providing for a complementary data state onto a portion of said optical medium;
(2) detecting said complementary data state on said portion of said optical medium.
(3) authenticating said optical medium upon detection of said complementary data state on said pottion of said optical medium.

14. The method of claim 13 wherein said complementary data state entails a change from one valid data state to a different valid data state.

15. The method of claim 13 wherein said complementary data state entails a change from one erroneous data state to a different erroneous data state.

16. The method of claim 13 wherein said complementary data state entails a change from a valid data state to an erroneous data state.

17. The method of claim 13 wherein said complementary data state entails a change from an erroneous data state to a valid data state.
